(19) United States
(12) Patent Application Publication
(10) Pub. No.: US 2007/0053190 A1
(43) Pub. Date: Mar. 8, 2007

(54) Compact efficient light collection optics for scrolling color illumination

(75) Inventor: Peter Johannes Michiel Janssen, Scarborough, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/557,348

(22) PCT Filed: May 17, 2004
(86) PCT No.: PCT/IB04/01731

§ 371 Date: Nov. 21, 2005

(51) Int. Cl. F21V 7/00

(52) U.S. Cl. 362/297; 362/19; 362/551

(57) ABSTRACT

A light source for a scrolling color illumination system includes a lamp (212) producing light, first and second independent reflectors (220, 230) each receiving a portion of the light from the lamp (212), and a light guide (260) receiving two independent images of the light source created by the portions of the light received by the first and second independent reflectors (220, 230). Through such an arrangement, the light guide (260) provides a light beam at an output thereof having an aspect ratio that is twice an aspect ratio of the light beam produced by the lamp (212) while preserving its original etendue. Beneficially, a polarizing element (266) polarizes the unpolarized light beam from the light guide (260) and, in the process, the aspect ratio is further doubled, again without an increase in the etendue.

This invention pertains to the field of light sources, and more particularly, to light collection optics for a scrolling color illumination system that may be used with a single panel scrolling color projection system.

A scrolling color projector produces full color images from a single light modulator, or light valve, (e.g., a liquid crystal display panel). The general concepts regarding a scrolling color projector are discussed in U.S. Pat. No. 5,532,763 to Janssen et al, (“the '763 patent”), the entire disclosure of which is incorporated herein by reference.

As described in the '763 patent, a scrolling color projector illuminates the liquid crystal display (LCD) panel with multiple stripes of colored light (red, green, blue) that continuously scroll, from top to bottom, over the liquid crystal display LCD. Light from an intense white light source, for example an arc lamp, is collected, and separated into primary colors-red, green and blue. The color-separated light is caused to be formed into three sources such that each source appears to be narrow in the “vertical” direction and wider in the “horizontal” direction. Scanning optics are employed to cause three bands of light, one of each of the colors, to be positioned onto the LCD panel. Scanning optics cause the bands of illumination to move across the LCD panel. As a band passes over the “top” of the active area of the panel a band of light of that color again appears at the “bottom” of the panel. Accordingly, there is a continuous sweep of three colors across the panel.

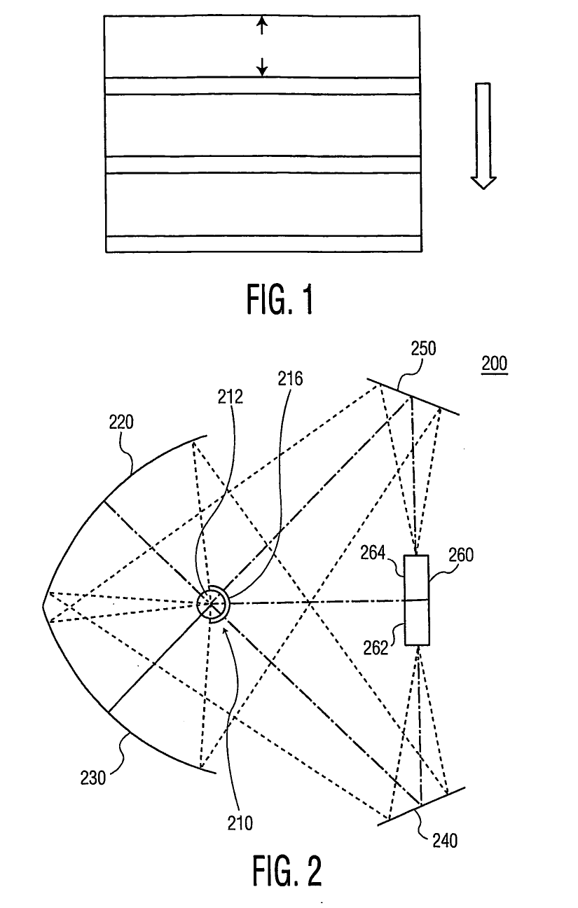

FIG. 1 shows a schematic representation of the illumination of an electro-optic light modulator panel in a scrolling color system. Such a panel is typically composed of a matrix of rows (or lines) and columns of pixels defined by individually addressable reflective pixel electrodes (not shown), addressed in a line-at-a-time manner. Red, blue and green rectangular-shaped color light bars (32, 36, 40) continuously scroll down the matrix array (represented by box 42) in the direction of the arrow. Red color bar 32, blue color bar 34 and green color bar 36 are shown illuminating the panel at instant of time t. The spaces between the color bars 32, 36 and 40 represent guard bars 30, 34 and 38.

The system described in the '763 patent includes a light box for producing the source light beam. The light box includes a lamp of suitable intensity. As described above and seen in FIG. 1, the light beam is required to be narrow in the “vertical” direction and wider in the “horizontal” direction. A typical system may require a rectangular light beam having an aspect ratio of 10:1. Meanwhile, the aspect ratio of a typical UHP arc lamp is 2.5:1. So, the light box also includes a series of optical lenses that serve to modify the beam of light so that it is in the required form of a generally uniform rectangular beam with the desired aspect ratio. The system may also include one or more vertically disposed rectangular apertures to further rectangularize the light beam from the light box, or the three different colored light beams after they have been color-separated.

Unfortunately, there are problems with these light sources. In order to collect most of the light produced by the lamp, one of two approaches is generally employed: (1) employing a large number of small numerical aperture (NA) lenses; and (2) employing a small number of high NA lenses. Both approaches suffer from disadvantages. In the case of approach (1), the disadvantages pertain to the complexity of so many lenses. In the case of approach (2), the high NA lenses require a high degree of heat tolerance. Both approaches suffer from high costs.

Accordingly, it would be desirable to provide an improved light source for a scrolling color illumination system for a scrolling color projector. It would also be desirable to provide a more compact optical arrangement for converting light from a lamp to a light beam having a desired form factor. It would be further desirable to provide efficient light collection optics for a scrolling color illumination system. The present invention is directed to addressing one or more of the preceding concerns.

In one aspect of the invention, a light source comprises: a lamp emitting light; a pair of partial-ellipsoidal reflectors positioned to receive the reflected light from the lamp and to direct the received light in first and second directions, respectively; first and second mirrors, each positioned to receive and reflect the light from one of the partial-ellipsoidal reflectors; and a light guide having two prisms disposed at a first end thereof, each prism being adapted to input into the light guide the reflected light from a corresponding one of the first and second mirrors, said light guide being adapted to provide a light beam at a second end thereof. In another aspect of the invention, a light source comprises: first and second partial-ellipsoidal reflectors each having first and second focal points, the partial-ellipsoidal reflectors being arranged such that the first focal points of the first and second partial-ellipsoidal reflectors generally coincide; a lamp generally positioned at the first focal points of the first and second partial-ellipsoidal reflectors; and a light guide disposed in a location where it receives, via the partial-ellipsoidal reflectors, two independent images of light produced by the lamp when the lamp is turned on.

In yet another aspect of the invention, a light source comprises a lamp producing light, first and second independent reflectors each receiving a portion of the light from the lamp, and a light guide receiving two independent images of the light source created by the portions of the light received by the first and second independent reflectors.

FIG. 1 shows a schematic representation of the illumination of an electro-optic light modulator panel in a scrolling color system;

FIG. 2 shows a cross-sectional schematic representation of an embodiment of a light source for a scrolling color illumination system;

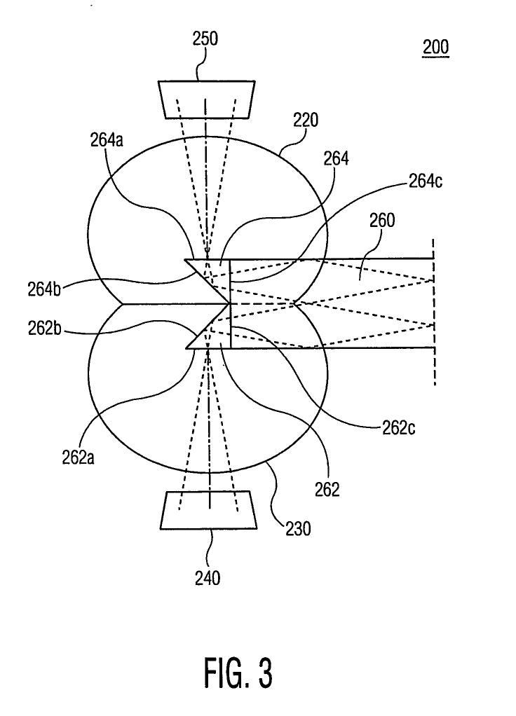

FIG. 3 shows a heads-on schematic representation of the light source for a scrolling color illumination system of FIG. 2;

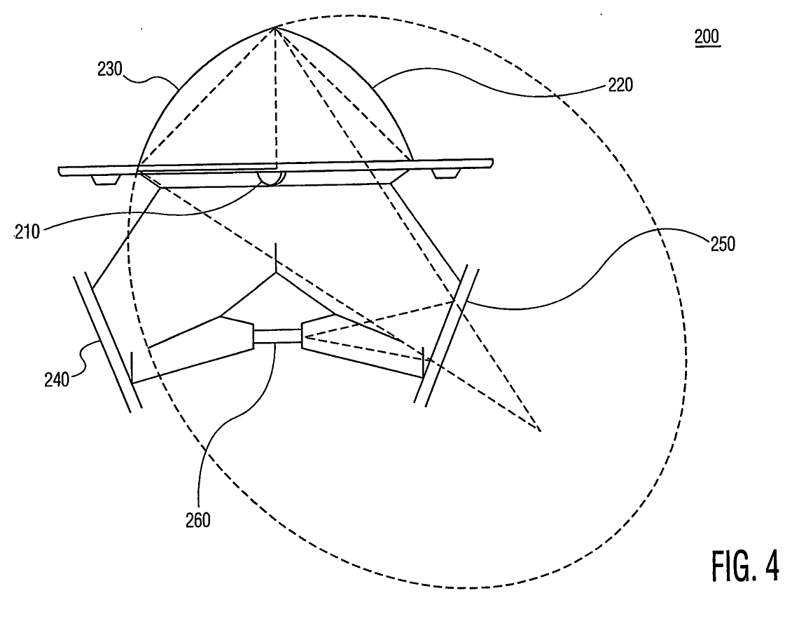

FIG. 4 shows a side view of an embodiment of a light source for a scrolling color illumination system;

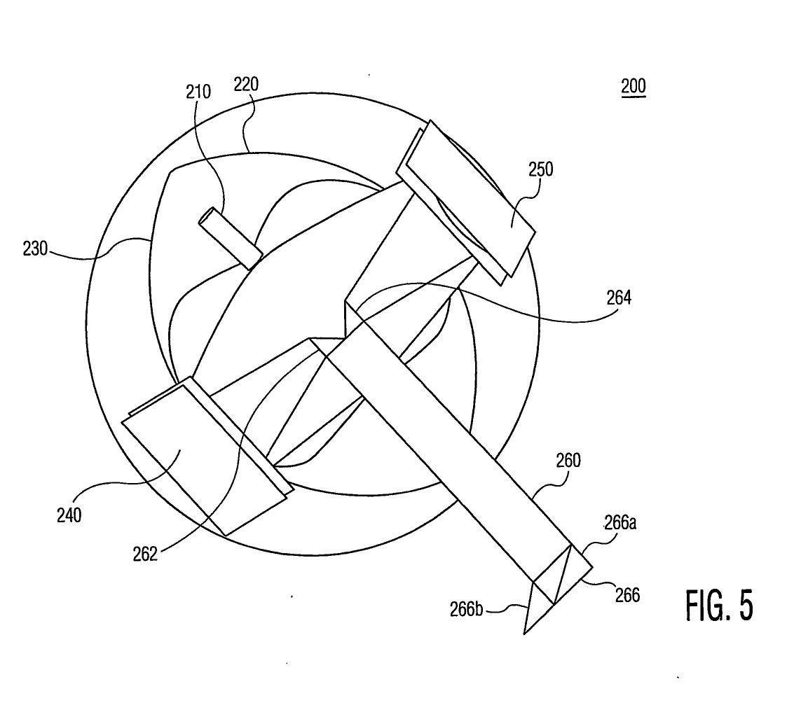

FIG. 5 shows a heads-on view of the embodiment of a light source for a scrolling color illumination system of FIG. 4;

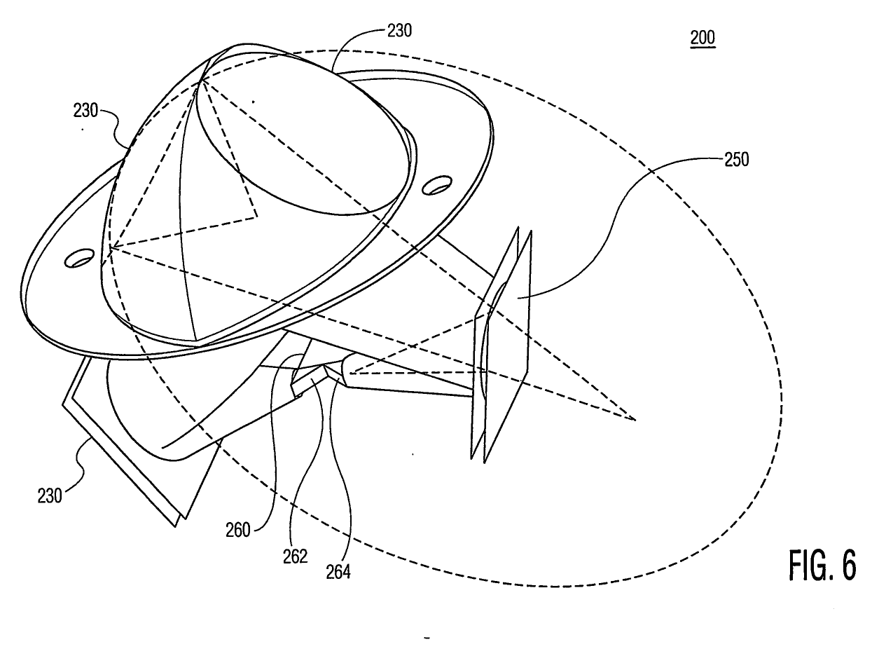

FIG. 6 shows a perspective view of the embodiment of a light source for a scrolling color illumination system of FIG. 4; and

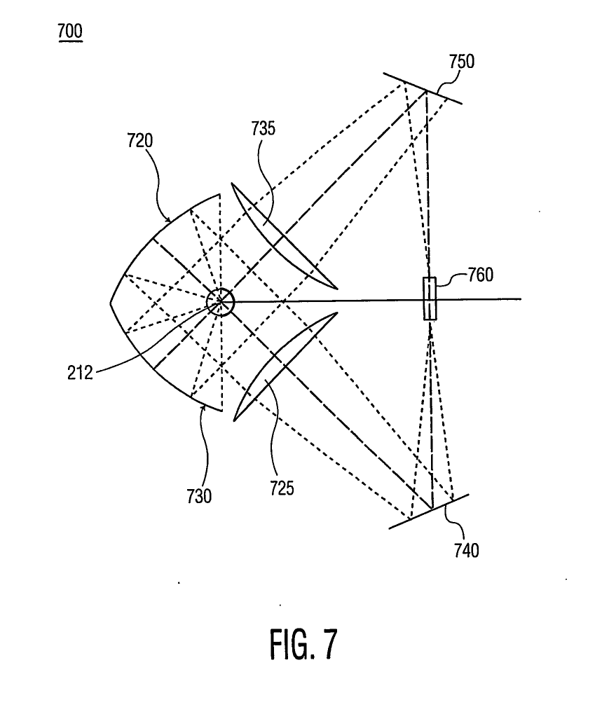

FIG. 7 shows a cross-sectional schematic representation of another embodiment of a light source for a scrolling color illumination system.

FIG. 2 shows a cross-sectional side view of an embodiment of a light source 200 for a scrolling color illumination system. FIG. 3 shows a heads-on view of the light source 200. As shown in FIGS. 2 and 3, the light source 200 includes: a lamp assembly 210 comprising a lamp 212 and a reflector 216; independent first and second partial-ellipsoidal reflectors 220 and 230; first and second mirrors 240 and 250; and a light guide 260.

Beneficially, the lamp 212 may be a high intensity discharge (HID) lamp or an ultra high performance (UHP) lamp and is preferably tubular in shape. An exemplary lamp may be about 9 mm in length.

Also the lamp reflector 216 beneficially has the general shape of a half-sphere or, depending upon the shape of the lamp 212, a half-cylinder. Preferably, the lamp assembly 210 emits light to only one side thereof, as will also be described in greater detail below. The light from the lamp assembly 210 may be a generally rectangular/elliptical shape. In an exemplary embodiment, the light produced by the lamp has an aspect ratio of 2.5:1.

As can be best seen in FIG. 4, the first and second partial-ellipsoidal reflectors 220 and 230 each define a partial surface of an ellipsoid having first and second focal points. Beneficially, first and second the partial-ellipsoidal reflectors 220 and 230 are arranged such that the first focal points generally coincide. Furthermore, as can be best seen in FIG. 2, the first and second partial-ellipsoidal reflectors 220 and 230 each have cross-sections defining an arc portion of an ellipse. Also beneficially, as best seen in FIG. 6, the first and second partial-ellipsoidal reflectors 220 and 230 share a common edge and are joined together at this common edge. In one embodiment, the first and second partial-ellipsoidal reflectors 220 and 230 are formed together in a unitary structure, as shown in FIGS. 4-6.

The light guide 260 is provided at a first (light entrance) end with first and second prisms 262 and 264. The prisms 262 and 264 may be bonded to the first end of the light guide 260 with a low-index-of-refraction cement, or optionally, may be formed integral to the light guide 260. The prisms 262 and 264 have corresponding light entrance facets 262a, 264a, light reflection facets 262b, 264b, and light exit facets 262c, 264c. The reflection facets 262b, 264b are beneficially provided with a reflective or mirror coating.

Also, as can best be seen in FIG. 5, the light guide 260 is beneficially provided at a second (light exit) end with a polarizing element 266. The polarizing element 266 includes a polarizing beamsplitter 266a and a phase retarder 266b whose operation will be described in further detail below. The beamsplitter 266a may be bonded to an end of the light guide 260 with a low-index-of-refraction cement, or optionally, may be formed integral to the light guide 260.

In the light source 200, the lamp assembly 210 is located generally at the first focal points of the partial-ellipsoidal reflectors 220 and 230. Meanwhile, the first and second mirrors 240 and 250 are each located in an optical path between the first and second partial-ellipsoidal reflectors 220 and 230, respectively, and their corresponding second focal points. Furthermore, the light entrance facets 262a, 264a of the prisms 262 and 264 are each located where an arc image from a corresponding one of the first and second partial-ellipsoidal reflectors 220 and 230 is relayed by a corresponding mirror 240, 250. That is to say, for example, that a sum of a distance “x” between the first partial-ellipsoidal reflector 220 and the mirror 240, and a distance “y” between the mirror 240 and the entrance light facet 262a, equals a focal length f2 of the second focal point of the first partial-ellipsoidal reflector 220.

The operation of the light source 200 will now be described. The lamp 212 radiates light A first portion of light from the lamp 212 radiates toward the lamp reflector 216. The lamp reflector 216 reflects the first portion of the light from the lamp 212 towards the first and second partial-ellipsoidal reflectors 220 and 230. Meanwhile, the remainder (second portion) of the light from the lamp 212 directly radiates toward the first and second partial-ellipsoidal reflectors 220 and 230. Beneficially, the lamp assembly 210 and the first and second partial-ellipsoidal reflectors 220 and 230 are arranged such that substantially all of the light from the lamp assembly 210 impinges on the interior surfaces of the first and second partial-ellipsoidal reflectors 220 and 230. That is, the first and second partial-ellipsoidal reflectors 220 and 230 each extend to far enough along the correspondingly-defined ellipsoid to receive substantially all of the light from the lamp 212 and the lamp reflector 216.

Advantageously, the lamp 212 is located generally at the first focal point of each of the first and second partial-ellipsoidal reflectors 220 and 230.

The first and second partial-ellipsoidal reflectors 220 and 230 receive the light from the lamp 212 (either directly or reflected by the lamp reflector 216) and produce independent arc images which are directed toward their respective second focal points.

Mirrors 240 and 250 are each located in an optical path between a corresponding one of the first and second partial-ellipsoidal reflectors 220 and 230 and the second focal point of the corresponding partial-ellipsoidal reflector 220/230. The mirrors 240 and 250 each receive the light from the corresponding partial-ellipsoidal reflector 220/230 and reflect the received light toward a corresponding one of the two prisms 262 and 264. The light entrance facets 262a and 264a of the two prisms 262, 264 are each disposed at the location of the image of the corresponding partial-ellipsoidal reflector 220/230, as relayed by the mirrors 240 and 250.

The independent light images enter the prisms 262 and 264 via the light entrance facets 262a and 264a, and are thereby passed to the corresponding light reflection facets 262b and 264b. The light is reflected by the light reflection facets 262b and 264b and enters the first end of the light guide 260 via the light exit facets 262c and 264c of the prisms 262 and 264. Accordingly, the two independent light images enter the light guide arranged “end-to-end” lengthwise adjacent to each other to produce a combined light beam having twice the aspect ratio of the original light beam from the lamp 212. The light is guided internally by the light guide 260 and emerges from the second end thereof.

Although the described embodiment includes the mirrors 240 and 250 and the two prisms 262 and 264, other means for receiving the independent light images and coupling the light images into the light guide 260 may be provided.

Advantageously, as a result of the above-described process, the aspect ratio of the light beam produced by the lamp 212 has been effectively doubled, without a corresponding increase in the etendue of the light beam and with relatively little loss of light or decrease in efficiency. For example, if the aspect ratio of the light beam from a typical UHP arc lamp is 2.5:1, then the aspect ratio of the light stripe emerging from the second end of the light guide 260 according to the above-described system and process would be 5:1.

For operation in a scrolling color projector, the LCD panel requires linearly polarized light. However, the light beam from the lamp 212 is unpolarized.

Accordingly, as mentioned above, the light guide 260 is beneficially provided with the polarizing element 266 at the second end thereof from which the light beam emerges. As can best be seen in FIG. 6, an unpolarized light beam from the light guide 260 enters the polarizing beamsplitter 266a. The portion of the light beam having a first (e.g., horizontal) polarization passes through the polarizing beamsplitter 266a, while the remainder of the light beam having the second (e.g., vertical) polarization is reflected to the phase retarder 266b. The light having the second (e.g., vertical) polarization is rotated in phase by 90 degrees by the phase retarder 266b and thereby its polarization is changed to the first (e.g. horizontal) polarization, before being reflected along a path adjacent and parallel to the path of the light having the first (e.g. horizontal) polarization that passes through the polarizing beamsplitter 266a.

Advantageously, as a result of the above-described polarization process, the aspect ratio of the linearly polarized light beam that emerges from the polarizing element 266 is doubled with respect to the aspect ratio of the unpolarized light beam that entered the polarizing element 266, without a corresponding increase in the etendue of the light beam and with very little loss of light or decrease in efficiency. That is, the light beam that passes through the polarizing element 266 has an aspect ratio that is four times the aspect ratio of the light originally produced by the lamp 212.

Accordingly, for example, if the aspect ratio of the light beam from a typical UHP arc lamp is 2.5:1, the aspect ratio of the light stripe entering the first end of the light guide 260 would be 5:1 and the aspect ratio of the light stripe emerging from the polarizing element 266 at the second end of the light guide 260 would be 10:1.

Therefore, by providing two independent reflectors that each create an independent image of the arc from the lamp, and combining the light of the two independent images, the etendue of the light beam can be preserved while adjusting the aspect ratio of the beam without the costs and complexity associated with employing a large number of small numerical aperture (NA) lenses; or a small number of high NA lenses.

The principles explained above in detail with respect to embodiments shown in FIGS. 1-6 can be expanded as follows. First, the images produced by the dual reflectors may be collected and combined in a variety of ways other than via the folding mirrors 240, 250 and corresponding prisms 262 and 264 illustrated in FIGS. 1-6. For example, a “Y-shaped” light guide may be employed having two entrance facets located at the image points of the two independent reflectors, the combined light beam emerging from a single common exit facet of the Y-shaped light guide. In that case, neither the mirrors not the prisms may be required.

Furthermore, the dual independent reflectors can assume shapes other than partial-ellipsoids. For example, parabolic or spherical reflectors can be employed.

FIG. 7 illustrates an alternative arrangement of a light source 700 employing two independent parabolic reflectors 720, 730, instead of the partial-ellipsoidal reflectors 220 and 230 of FIGS. 1-6. The light source 700 also includes magnifying lenses 725 and 735 that produce corresponding independent images of the light from the lamp 710 reflected as two sets of parallel light rays by the independent parabolic reflectors 720 and 730. In the illustrated embodiment, each of the magnifying lenses 725 and 735 has a magnification factor of “4.” As before, the light guide 760 is arranged so that it receives the two independent light images. The remaining structure and operation of the light source 700 are similar to those of the light source 200 described in detail above, and therefore will be omitted here for brevity.

Also, the lamp reflector may be omitted from the light source. Although some light from the lamp will be lost in that case, such an arrangement may increase the life-span and reliability of the lamp as compared to the case shown in FIGS. 1-6 where the lamp reflector can reflect a significant amount of heat-generating light back into the lamp.

Finally, the principles can be expanded to produce etendue-preserving light beams having different aspect ratios. For example, instead of combining the light images “lengthwise,” the light guide could be constructed so that the light images are received adjacently to produce a more “square-shaped” light beam, while still preserving the etendue of the original beam. Additionally, or alternatively, the polarizing element at the second (exit) end of the light guide could be constructed with the polarizing beamsplitter and phase retarder oriented so that the aspect ratio of the polarized light beam is cut in half, instead of doubled, with respect to the unpolarized light beam entering the polarizing element.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A light source, comprising:
a lamp producing light;
first and second partial-ellipsoidal reflectors each positioned to receive a portion of the light from the lamp and to direct the received light in corresponding first and second directions, each partial-ellipsoidal reflector producing an independent image of the light produced by the lamp;
first and second mirrors, each positioned to receive and reflect the light from one of the partial-ellipsoidal reflectors; and
a light guide having two prisms disposed at a first end thereof, each prism being adapted to input into the light guide a corresponding one of the independent images produced by the partial-ellipsoidal reflectors, said light guide being adapted to provide a light beam at a second end thereof.

2. The light source of claim 1, further including a polarizing element disposed at the second end of the light guide, said polarizing element being adapted to receive the light beam at the second end of the light guide and to convert the light beam into a polarized light beam, wherein the aspect ratio of the polarized light beam is twice the aspect ratio of the light beam received by the polarizing element.

3. The light source of claim 2, wherein the polarizing element includes a polarizing beamsplitter and a phase retarder.

4. The light source of claim 1, wherein the pair of partial-ellipsoidal reflectors are joined together along a common edge thereof.

5. A light source, comprising:
first and second partial-ellipsoidal reflectors each having first and second focal points, the partial-ellipsoidal reflectors being arranged such that the first focal points of the first and second partial-ellipsoidal reflectors generally coincide;
a lamp generally positioned at the first focal points of the first and second partial-ellipsoidal reflectors; and
a light guide disposed in a location where it receives, via the partial-ellipsoidal reflectors, two independent images of light produced by the lamp when the lamp is turned on.

6. The light source of claim 5, further comprising first and second mirrors disposed in an optical path between a corresponding one of the first and second partial-ellipsoidal reflectors and their respective second focal points.

7. The light source of claim 5, further including first and second prisms disposed at an end of the light guide.

8. The light source of claim 5, further comprising a lamp reflector arranged to reflect a portion of the light produced by the lamp towards the first and second partial-ellipsoidal reflectors when the lamp is turned on.

9. The light source of claim 5, further including a polarizing element disposed at the second end of the light guide.

10. The light source of claim 9, wherein the polarizing element includes a polarizing beamsplitter and a phase retarder.

11. The light source of claim 9, wherein the polarizing element is adapted to double an aspect ratio of the light provided at the second end of the light guide.

12. The light source of claim 5, wherein the first and second partial-ellipsoidal reflectors share a common edge.

13. A light source, comprising:
a lamp producing light;
first and second independent reflectors each receiving a portion of the light from the lamp; and
a light guide receiving two independent images of the light source created by the portions of the light received by the first and second independent reflectors.

14. The light source of claim 13, wherein the first and second independent reflectors each have a shape of a partial ellipsoid.

15. The light source of claim 13, wherein the first and second independent reflectors each have a shape of a paraboloid.

16. The light source of claim 15, further comprising a pair of lenses each receiving reflected light from a corresponding one of the parabolic reflectors and creating one of the images from the reflected light.

17. The light source of claim 16, further comprising a pair of mirrors each disposed in an optical path between a corresponding one of the lenses and its image, each said mirror being adapted to direct light from the lens toward the light guide.

18. The light source of claim 13, wherein the light guide is adapted to provide a light beam at an output thereof, where the light beam has an aspect ratio that is twice an aspect ratio of the light produced by the lamp.

19. The light source of claim 13, further comprising a pair of mirrors each receiving reflected light from a corresponding one of the independent reflectors and directing the reflected light toward the light guide.

20. The light source of claim 13, further including a polarizing element disposed at the second end of the light guide, said polarizing element being adapted to receive the light beam at the second end of the light guide and to convert the light beam into a linearly-polarized light beam, wherein the aspect ratio of the linearly-polarized light beam is twice the aspect ratio of the light beam received by the polarizing element.
